(19) United States
(12) Patent Application Publication
(10) Pub. No.: US 2025/0374392 A1
(43) Pub. Date: Dec. 4, 2025

(54) HEAT MOLDING MODE FOR AN OVEN APPLIANCE

(71) Applicant: Haier US Appliance Solutions, Inc., Wilmington, DE (US)

(72) Inventors: Kathy Nguyen, Louisville, KY (US); Katie Hawboldt Lacy, Louisville, KY (US)

(21) Appl. No.: 18/678,944

(22) Filed: May 30, 2024

(51) Int. Cl. H05B 6/80

(52) U.S. Cl. CPC H05B 6/80

(57) ABSTRACT

An oven appliance may include a cabinet defining a cooking chamber. The oven appliance may include a user interface panel mounted to the cabinet for facilitating user interaction with the oven appliance. The oven appliance may include a controller in operative communication with the user interface panel. The controller may be configured for: receiving an input command for a heat molding mode; obtaining a heat molding profile of a non-food item in response to receiving the input command; determining mold settings of the oven appliance according to the obtained heat molding profile; and initiating a heat molding operation after determining the mold settings of the oven appliance.

### FIELD OF THE DISCLOSURE

The present subject matter relates generally to an oven appliance and more particularly to a heat molding mode for an oven appliance.

### BACKGROUND OF THE DISCLOSURE

Conventional residential and commercial oven appliances generally include a cabinet that includes a cooking chamber for receipt of food items for cooking. Multiple heating elements are positioned within the cooking chamber to provide heat to food items located therein. In addition, conventional oven appliances include a cooktop positioned on a top of the appliance that includes one or more heating elements, such as electric heaters, gas burners, or induction heating elements. Cooking appliances that include both an oven and a cooktop are commonly referred to as “ranges.”

Users are increasingly interacting and engaging with their oven appliances outside of traditional cooking or baking. For example, users can use their oven appliance to heat mold objects, such as sporting goods or various medical products. However, further improvements are necessary to improve the utilization of oven appliances outside of traditional cooking or baking. Particularly, these nontraditional uses of the oven appliance often require precious mold settings, such as temperatures or cooking times. These mold settings can present numerous challenges for users. For example, users often lack knowledge of these mold settings or the specific characteristics of a given non-food item. Thus, if the mold settings are not accurately or conveniently given to the user, it can be difficult to achieve the desired heat molding result reliably (e.g., without inadvertently harming the finish or durability of the non-food item).

Accordingly, systems and methods for an oven appliance that obviate one or more of the above-mentioned features would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, an oven appliance is provided. The oven appliance may include a cabinet defining a cooking chamber. The oven appliance may include a user interface panel mounted to the cabinet for facilitating user interaction with the oven appliance. The oven appliance may include a controller in operative communication with the user interface panel. The controller may be configured for: receiving an input command for a heat molding mode; obtaining a heat molding profile of a non-food item in response to receiving the input command; determining mold settings of the oven appliance according to the obtained heat molding profile; and initiating a heat molding operation after determining the mold settings of the oven appliance.

In another exemplary aspect of the present disclosure, a method of operating an oven appliance is provided. The method may include receiving an input command for a heat molding mode. The method may include obtaining a heat molding profile of a non-food item in response to receiving the input command. The method may include determining mold settings of the oven appliance according to the obtained heat molding profile. The method may include initiating a heat molding operation after determining the mold settings of the oven appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an oven appliance according to an exemplary embodiment of the present subject matter.

FIG. 2 provides a side cross-sectional view of the exemplary oven appliance of FIG. 1 according to an exemplary embodiment of the present subject matter.

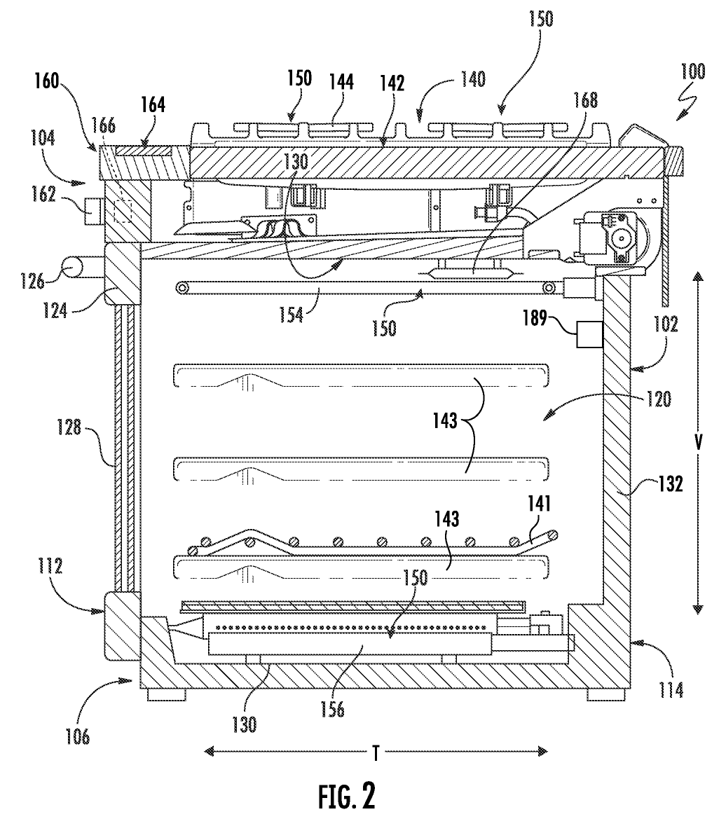

FIG. 3 provides a method of operating an oven appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

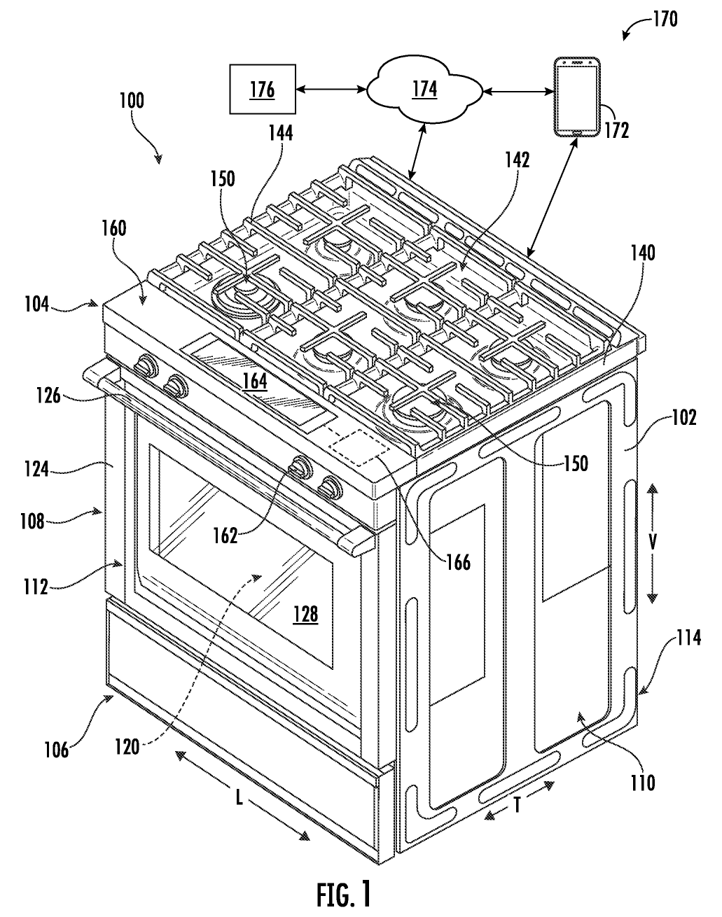

FIG. 1 provides a front, perspective view of an oven appliance 100 as may be employed with the present subject matter. Oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to display assemblies for any suitable appliance.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

In general, cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

In some embodiments, one or more baking racks 141 are positioned in cooking chamber 120 for the receipt of food items or utensils containing food items. The one or more baking racks 141 may be slidably received onto embossed ribs or sliding rails 143 such that the one or more baking racks 141 may be conveniently moved into and out of cooking chamber 120 when door 124 is open. Additionally or alternatively, a cooking assembly 200 (e.g., described in more detail below) may be received onto one or more baking racks 141.

Oven appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 are supported on a top surface of top panel 142 for supporting cooking utensils, such as pots or pans, during a cooking process.

Oven appliance 100 may further include one or more heating elements (identified generally by reference numeral 150) for selectively heating cooking utensils positioned on grates 144 or food items positioned within cooking chamber 120. For example, referring to FIG. 1, heating elements 150 may be gas burners 150. Specifically, a plurality of gas burners 150 are mounted within or on top of top panel 142 underneath grates 144 that supports cooking utensils over the gas burners 150 while gas burners 150 provide thermal energy to cooking utensils positioned thereon, e.g., to heat food or cooking liquids (e.g., oil, water, etc.). Gas burners 150 can be configured in various sizes so as to provide e.g., for the receipt of cooking utensils (i.e., pots, pans, etc.) of various sizes and configurations and to provide different heat inputs for such cooking utensils. According to alternative embodiments, oven appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on, e.g., the size of oven appliance 100 or the desired heat output. Oven appliance 100 may include any other suitable number, type, and configuration of heating elements 150 within cabinet 102 or on cooktop 140. For example, oven appliance 100 may further include electric heating elements, induction heating elements, or any other suitable heat generating device.

A control panel assembly 160 is located within convenient reach of a user of the oven appliance 100. For this example embodiment, control panel assembly 160 is positioned at a top 104 and front 112 of cabinet 102, e.g., above door 124 along the vertical direction V and forward of cooktop 140 along the transverse direction T. Control panel assembly 160 includes knobs 162 that are each associated with one of heating elements 150. In this manner, knobs 162 allow the user to activate each heating element 150 and determine the amount of heat input provided by each heating element 150 for cooking food items within cooking chamber 120 or on cooktop 140. Although shown with knobs 162, it should be understood that knobs 162 and the configuration of oven appliance 100 shown in FIG. 1 is provided by way of example only. More specifically, control panel assembly 160 may include various input components, such as one or more of a variety of touch-type controls, electrical, mechanical or electro-mechanical input devices including rotary dials, push buttons, and touch pads. Control panel assembly 160 may also be provided with one or more graphical display devices or display components, such as a digital or analog display device designed to provide operational feedback or other information to the user such as e.g., whether a particular heating element 150 is activated or the rate at which the heating element 150 is set. Indeed, according to the illustrated embodiment, control panel assembly 160 includes a display assembly 164, such as a liquid crystal display with an interactive display and interface.

Generally, oven appliance 100 may include a controller 166 in operative communication with control panel assembly 160. Control panel assembly 160 of oven appliance 100 may be in communication with controller 166 via, for example, one or more signal lines or shared communication busses, and signals generated in controller 166 operate oven appliance 100 in response to user input via user input devices, e.g., control knobs 162 or display assembly 164. Input/Output (“I/O”) signals may be routed between controller 166 and various operational components of oven appliance 100 such that operation of oven appliance 100 can be regulated by controller 166. In addition, controller 166 may also be in communication with one or more sensors, such as temperature sensor 168, which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Additionally or alternatively, the oven appliance 100 may include one or more non-contact temperature sensors 189 positioned within or otherwise in thermal communication with the cooking chamber 120 of the oven appliance 100. Particularly, the one or more non-contact temperature sensors 189 may be temperatures sensors that are capable of determining the temperature of items (e.g., the non-food item described in more detail below) that may be placed or positioned within the cooking chamber 120 (e.g., separate from or in addition to a general temperature of the cooking chamber 120) without direct contact with the surface of the items. For example, the one or more non-contact temperature sensors 189 may be or may include infrared (IR) sensors (e.g., a temperature sensor that uses infrared radiation to measure the temperature of non-food item) or thermal scanners (e.g., a thermal imaging camera). The one or more non-contact sensors may generally be directed or otherwise capable of discerning an item (e.g., a food item or a non-food item) that may be positioned within the cooking chamber 120.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog or digital logic circuitry (such as switches, amplifiers, integrators, comparators, flip-flops, AND gates, and the like) to perform control functionality instead of relying upon software.

Referring still to FIG. 1, a schematic diagram of an external communication system 170 will be described according to an exemplary embodiment of the present subject matter. In general, external communication system 170 is configured for permitting interaction, data transfer, and other communications between oven appliance 100 and one or more external devices. For example, this communication may be used to provide and receive operating parameters, user instructions or notifications, performance characteristics, user preferences, or any other suitable information for improved performance of oven appliance 100. In addition, it should be appreciated that external communication system 170 may be used to transfer data or other information to improve performance of one or more external devices or appliances or improve user interaction with such devices.

For example, external communication system 170 permits controller 166 of oven appliance 100 to communicate with a separate device external to oven appliance 100, referred to generally herein as an external device 172. As described in more detail below, these communications may be facilitated using a wired or wireless connection, such as via a network 174. In general, external device 172 may be any suitable device separate from oven appliance 100 that is configured to provide or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with oven appliance 100 or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control oven appliance 100, etc. In addition, external device 172 and remote server 176 may communicate with oven appliance 100 to communicate similar information.

In general, communication between oven appliance 100, external device 172, remote server 176, or other user devices or appliances may be carried using any type of wired or wireless connection and using any suitable type of communication network, non-limiting examples of which are provided below. For example, external device 172 may be in direct or indirect communication with oven appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

According to various embodiments of the present disclosure, the oven appliance 100 may be configured for a precision cooking mode or methods of operating the oven appliance 100 according to an included precision cooking mode. Precision cooking modes generally include a closed loop control algorithm used to automatically (e.g., without user input) adjust the heating levels of one or more of the heating elements positioned within or otherwise in thermal communication with the cooking chamber 120 (e.g., heating element(s) 150). Closed loop control algorithms are generally understood by those of ordinary skill in the art, e.g., wherein temperature measurements are compared to target temperature or setpoint temperature (e.g., user-defined or predetermined setpoint temperature) to adjust the power level of one or more respective heating elements. Utilizing temperature measurements from one or more of the temperature sensors 168 or 189, controller 166 may adjust the control device(s) associated with the heating element 150 currently in use. In other words, utilizing temperature measurements from one or more of the temperature sensors 169 or 189, controller may activate or deactivate the heating element 150 currently in use. For example, the user may turn on the closed loop control system by initiating precision cooking mode, such as by pressing or otherwise manipulating a corresponding one of the inputs or controls of the control panel assembly 160. In some embodiments, such inputs or controls of the control panel assembly 160 may also be used to input a user-defined set temperature or target temperature for the cooking operation.

When the closed loop control system is activated, controller 166 receives the temperature measurements from temperature sensor 168 or 189 and compares the temperature measurements to a target temperature. The target temperature may be provided as or include a user-defined set temperature or a predetermined target temperature based on a current stage of the precision cooking mode or based on a selected food attribute, e.g., type, quantity, volume, etc. In order to reduce a difference between the temperature measurements from the temperature sensor(s) and the target temperature, controller 166 may adjust the heating element(s) 150 (e.g., the respective control device thereof). Thus, the heat output provided by the heating elements 150 may be regulated by the closed loop control system, e.g., without additional user input or monitoring.

Although aspects of the present subject matter are described herein in the context of a single oven appliance, it should be appreciated that oven appliance 100 is provided by way of example only. Other oven or range appliances having different configurations, different appearances, or different features may also be utilized with the present subject matter, e.g., double ovens, connected oven/cooktop units, etc. Moreover, aspects of the present subject matter are equally applicable to standalone cooktops (e.g., without cooking chambers) or other cooking appliances.

Now that the construction and configuration of oven appliance 100 has been described according to exemplary embodiments of the present subject matter, an exemplary method 200 for operating oven appliance 100 will be described according to an exemplary embodiment of the present subject matter. Method 200 can be used to operate oven appliance 100 or may be used to operate any other suitable oven appliances. In this regard, for example, controller 166 may be configured for implementing some or all steps of method 200. Further, it should be appreciated that the exemplary method 200 is discussed herein only to describe exemplary aspects of the present subject matter and is not intended to be limiting.

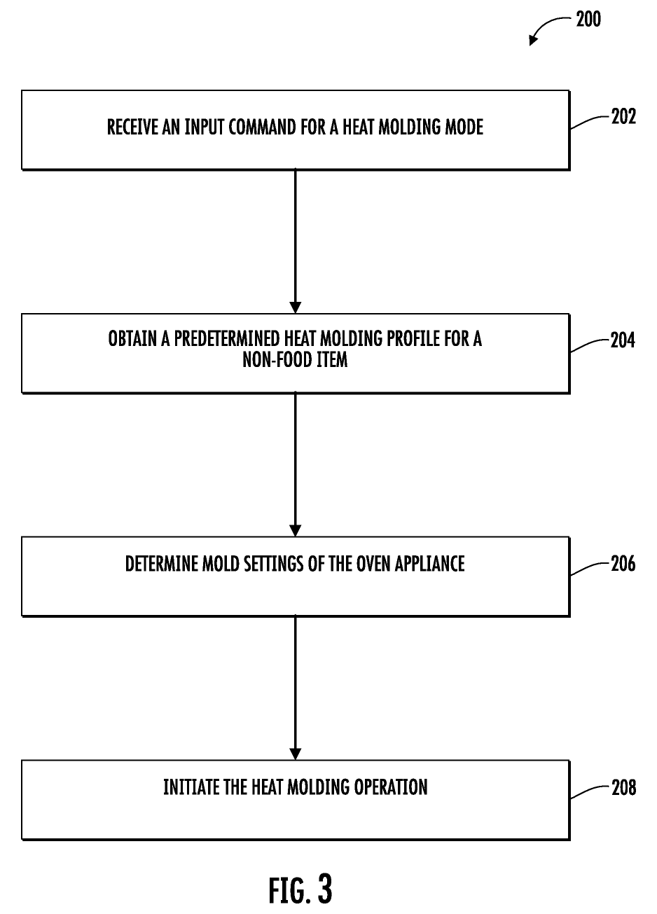

Referring now to FIG. 3, embodiments of the present subject matter may include one or more methods of operating an oven appliance, such as the exemplary oven appliance 100 described above, as well as other possible exemplary oven appliances. The exemplary methods according to the present subject matter may include a method 200, for example, as illustrated in FIG. 3. A controller of the oven appliance, such as the controller 166 of the exemplary oven appliance 100, may be programmed to implement method 200, for example, the controller, such as controller 166, may be capable of and may be operable to perform any methods and associated method steps as disclosed herein.

Advantageously, methods in accordance with the present disclosure provide a functional precision cooking mode for molding or warming non-food items (herein referred to as a “heat molding mode”), such as to permit controlled deformation permitting reshaping of a non-food item (e.g., in order to better complement or match a user’s body). Notably, the present disclosure may direct effective deformation or softening of the non-food item (e.g., quickly or efficiently) without requiring user knowledge of an item’s characteristics or harming finish or durability of the item. In general non-food items may include items such as sports equipment (e.g., gloves, ice skates, mouth guards, etc.), medical devices (e.g., braces, prosthetics, hearing devices, etc.), or any other suitable non comestible item that may be molded or warmed via an oven appliance. As will be explained a plurality of factors related to a heat molding operation of the heat molding mode may be altered, adjusted, saved, and implemented to specific heat molding profiles to readily mold or warm desired non-food items. Heat molding of non-food items may be performed via method(s) presented herein.

Method 200, at 202, may include receiving an input command for a heat molding mode. For instance, the input command may be a request from a user to perform a heat molding mode within the oven appliance. In some embodiments, the input command can be received directly on the oven appliance (e.g., via a user interface). The user may select the heat molding mode among a plurality of precision cooking modes. Particularly, at 202, a user may select a heat molding mode stored on board the oven appliance (e.g., within a memory associated with the oven appliance).

Additionally or alternatively, the input command for the heat molding mode may be received remotely. In detail, an external device (e.g., a mobile phone, a tablet, a smartwatch, etc.) may be remotely connected with the oven appliance (e.g., via a wireless connection). The external device may be in operative communication with the oven appliance, for instance, via a mobile application. Within the mobile application, the user may submit the input command. Accordingly, via the remote connection, the oven appliance may receive the input command.

Method 200, at 204, may include obtaining a heat molding profile of the non-food item in response to receiving the input command. Generally, the heat molding profile of the non-food item may be based on the thermal characteristics of the non-food item to be molded or warmed. The thermal characteristics of the non-food items may generally correspond to physical characteristics of the non-food item, such as the type of non-food item (e.g., sporting equipment, medical devices, etc.), one or more materials included in or as part of the non-food item (e.g., leather, synthetic leather, thermoforming plastic, etc.), or the size or shape of the non-food item (e.g., child size, adult size, large, small, thickness, etc.). In this regard, obtaining the heat molding profile of the non-food item may include discerning or detecting physical characteristics of the non-food items. In some embodiments, one or more sensors (e.g., camera(s)) positioned within the oven appliance may be capable of discerning or detecting physical characteristics of the non-food items. For instance, the cameras may be capable of performing one or more image processing techniques to discern or detect the physical properties of the non-food item.

In some embodiments, the heat molding profile obtained may be selected from one or more predetermined heat molding profiles for a variety of non-food items may be stored within a memory associated with the cooking appliance. For example, the heat molding profile obtained may be selected from one or more heat molding profiles for thermoforming plastics, ice skates, mouthguards, orthotics, dental appliances, thermoplastic splints and braces, gloves, polymer clays and crafts, etc., that may be stored within a memory associated with the cooking appliance.

In some other embodiments, the heat molding profile obtained may be created (e.g., via the transmission of one or more heating profile input commands). The heating profile input command may be received directly on the oven appliance (e.g., via a user interface). Additionally or alternatively, the heating profile input command may be received remotely via an external device remotely connected with the oven appliance. The user may input various information related to the non-food item. For example, the use may input the thermal characteristics of the non-food items, such as the type, the material, or the size or shape of the non-food item. Based on these inputs a heat molding profile may obtained (e.g., created) for the non-food item.

Method 200, at 206, may include determining mold settings of the oven appliance according to the obtained heat molding profile. In detail, within each respective heat molding profile particular mold settings of the oven appliance may be set. Mold settings of the oven appliance may include settings or characteristics of the oven appliance that may alter or otherwise impact the heating of an item within the oven appliance. For example, the mold settings of the oven appliance may generally include a power level of heating elements positioned within or otherwise in thermal communication with the oven appliance, a cook time of the oven appliance, a target temperature (e.g., detected by the non-contact temperature sensor(s)), or a rack position or level of a rack within the oven appliance.

In some embodiments, each of the heat molding profiles include particular mold settings related to the heating elements positioned within or otherwise in thermal communication with the cooking chamber. For example, the heating elements may include an upper heating element, a lower heating element, or a convection heating element. Each of the heat molding profiles may require each of the heating elements positioned within or otherwise in thermal communication with the cooking chamber to be directed or operated at one of a plurality of power levels. For example, each of the heat molding profiles may require each of the heating elements to be directed or operated at an off power level, an on power level, or a power level between the off power level and the on power level (e.g., as a discrete percentage or predetermined power level greater than an off or inactive power level and less than a full power level). Optionally, the power level may include a duty cycle or fuel flowrate setting.

In some embodiments, each of the predetermined heat molding profiles may additionally include a cooking time. For instance, the cooking time may be, or may include a length of time or time interval for which each of the heat elements are driven or operated (e.g., continuously or according to a set power level). The cooking time may apply to each of the heat elements collectively. For example, in some embodiments, each of the heating elements can have the same cooking time. However, in some other embodiments, the cooking time can vary among the heating elements. For instance, according to one or more heat molding profiles, a first or a second heating element may be driven for a first partial cooking time, while a third heating element may be driven for a second cooking time different from the first cooking time. In some other embodiments, different heating elements can be activated for different (e.g., overlapping, or non-overlapping) periods of time.

In some embodiments, each of the predetermined heat molding profiles can, additionally or alternatively, include a recommended rack level. The recommended rack level may correspond to a vertical position for a rack that is slidably received onto embossed ribs or sliding rails within the oven appliance. In addition, each predetermined heat molding profile may include a recommended cookware for the non-food item to be placed on. The recommend cookware may be to common household cookware, such as pots or pan, or may be no cookware at all, such as placing the non-food item directly onto the rack within the oven appliance. The recommended rack level and the recommended cookware may generally be based on an amount or a type of heat that the obtained heating profile requires the non-food item to receive from the one or more heating elements. For example, the recommended rack level and the recommend cookware may position the non-food item relative to the one or more heating elements such as to control an amount of direct or indirect heat that the non-food item receive.

Method 200, at 208, may include initiating the heat molding operation after determining the mold settings of the oven appliance. For instance, upon retrieving the mold settings of the cooking appliance, the method 200 may begin performing the heat molding operation. Thus, at least part of the initiation of the heat molding operation may include activating one or more heating elements positioned within or otherwise in thermal communication with the cooking chamber. For instance, each of the heating elements may receive power (e.g., electrical power or voltage) from the power source of the oven appliance to produce the mold settings of the oven appliance. Additionally or alternatively, at least part of the initiation of the heat molding operation may include initiating a cook time of the oven appliance. The cook time may be a predetermined cook time (e.g., based on the heat molding profile) that the one or more heating elements may be activated for.

In some embodiments, the method 200 is further configured for obtaining temperature measurements of the non-food item following initiating the heat molding operation. The temperature measurements may be obtained via one or more non-contact temperature sensors. The one or more non-contact temperature sensors may be temperatures sensors that are capable of determining the temperature of the non-food item without direct contact with the surface of the non-food item. For example, the one or more non-contact temperature sensors may be or may include infrared (IR) sensors (e.g., a temperature sensor that uses infrared radiation to measure the temperature of non-food item).

The temperature measurements of the non-food item may be transmitted to a controller associated with the oven appliance. In some embodiments, the temperature measurements obtained is transmitted continuously to the controller associated with the oven appliance. In such embodiments, after the heat molding operation has been initiated, the temperature of the non-food item positioned within the cooking chamber of the oven appliance may be repeatedly monitored (e.g., continuously or according to a set repetition interval for temperature measurement).

In some embodiments, the heat molding profile selected may include target temperatures for the non-food item positioned within the cooking chamber. The target temperatures may be based on the thermal characteristics of the non-food item. The controller may be capable of comparing the obtained temperature measurements to the target temperatures for the non-food items. In order to reduce a difference between the obtained temperature measurements from the temperature sensor(s) and the target temperature, controller may adjust the power level of the heating elements. Thus, the heat output provided by the heating elements may be regulated by the closed loop control system, e.g., without additional user input or monitoring. In some embodiments, when the obtained temperature measurements have met or exceeded the target temperatures, the method 200 may include deactivating the one or more heating elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance comprising:
a cabinet defining a cooking chamber;
a user interface panel mounted to the cabinet for facilitating user interaction with the oven appliance; and
a controller in operative communication with the user interface panel, the controller being configured for:
receiving an input command for a heat molding mode;
obtaining a heat molding profile of a non-food item in response to receiving the input command;
determining mold settings of the oven appliance according to the obtained heat molding profile; and
initiating a heat molding operation after determining the mold settings of the oven appliance.

2. The oven appliance of claim 1, wherein the obtained heat molding profile is based on thermal characteristics of the non-food item.

3. The oven appliance of claim 2, wherein the thermal characteristics of the non-food item correspond to a material of the non-food item.

4. The oven appliance of claim 2, wherein the thermal characteristics of the non-food item correspond to a size of the non-food item.

5. The oven appliance of claim 1, wherein determining mold settings of the oven appliance comprises determining a power level of one or more heating elements in thermal communication with the cooking chamber of the oven appliance.

6. The oven appliance of claim 1, wherein determining mold settings of the oven appliance comprises determining a cook time of the heat molding operation.

7. The oven appliance of claim 1, wherein determining mold settings of the oven appliance comprises determining a recommended rack level for a rack positioned within the cooking chamber of the oven appliance.

8. The oven appliance of claim 1, wherein initiating the heat molding operation comprises:
activating one or more heating elements positioned within a chamber of the oven appliance at a predetermined power level for a predetermined cook time.;

9. The oven appliance of claim 1, wherein the oven appliance comprises one or more non-contact temperature sensors in thermal communication with the cooking chamber.

10. The oven appliance of claim 9, wherein the controller is further configured for:
obtaining, with the one or more non-contact temperature sensors, temperature measurements of the non-food item within the cooking chamber following initiating the heat molding operation; and
adjusting one or more mold settings based on the obtained temperature measurements.

11. A method of operating an oven appliance, the method comprising:
receiving an input command for a heat molding mode;
obtaining a heat molding profile of a non-food item in response to receiving the input command;
determining mold settings of the oven appliance according to the obtained heat molding profile; and
initiating a heat molding operation after determining the mold settings of the oven appliance.

12. The method of claim 11, wherein the obtained heat molding profile is based on thermal characteristics of the non-food item.

13. The method of claim 12, wherein the thermal characteristics of the non-food item correspond to a material of the non-food item.

14. The method of claim 12, wherein the thermal characteristics of the non-food item correspond to a size of the non-food item.

15. The method of claim 11, wherein determining mold settings of the oven appliance comprises determining a power level of one or more heating elements in thermal communication with a cooking chamber of the oven appliance.

16. The method of claim 11, wherein determining mold settings of the oven appliance comprises determining a cook time of the heat molding operation.

17. The method of claim 11, wherein determining mold settings of the oven appliance comprises determining a recommended rack level for a rack positioned within a cooking chamber of the oven appliance.

18. The method of claim 11, wherein initiating the heat molding operation comprises:
activating one or more heating elements positioned within a chamber of the oven appliance at a predetermined power level for a predetermined cook time;

19. The method of claim 11, further comprising:
obtaining, with one or more non-contact temperature sensors in thermal communication with a cooking chamber, temperature measurements of the non-food item within a cooking chamber following initiating the heat molding operation; and
adjusting one or more mold settings based on the obtained temperature measurements.
